(19) United States
(12) Patent Application Publication
(10) Pub. No.: US 2011/0220059 A1
(43) Pub. Date: Sep. 15, 2011

(54) TWO-CYCLE COMBUSTION ENGINE

(76) Inventor: Josef Ganglmayr, Krenglbach (AT)

(21) Appl. No.: 12/998,579

(22) PCT Filed: Dec. 2, 2009
(86) PCT No.: PCT/AT2009/000466

§ 371 Date: May 5, 2011

(30) Foreign Application Priority Data
Dec. 2, 2008 (AT) A 1875/2008

(51) Int. Cl. F02M 61/14

(52) U.S. Cl. 123/299

(57) ABSTRACT

The invention relates to a two-cycle combustion engine, comprising at least one cylinder (1) accommodating a piston (2) and provided with a cylinder head, a crankcase (10) which is in fluid connection with the cylinder (1) by way of transfer ports (12 to 16) which are disposed symmetrically opposite of one another with respect to a diametral plane (5) of the cylinder (1) that is determined by the axis of an exhaust port (4), and two injection nozzles (6, 7) for fuel disposed symmetrically with respect to said diametral plane (5), the nozzle axes (8) of which intersect one another above the piston crown (3) in the diametral plane (5) in the bottom dead centre position of the piston (2). In order to create advantageous scavenging conditions, it is proposed that the nozzle axes (8) intersect one another on the side of the cylinder axis facing away from the exhaust port (4) and extend at least approximately in the outflow direction (17) of the transfer ports (12, 13) respectively provided on the opposite side of the diametral plane (5), and the piston (2) comprises a casing opening (21) for injecting fuel into the crankcase (10) on at least one circumferential side facing the injection nozzles (6, 7).

### FIELD OF THE INVENTION

The invention relates to a two-cycle combustion engine, comprising at least one cylinder accommodating a piston and provided with a cylinder head, a crankcase which is in fluid connection with a cylinder by way of transfer ports which are disposed symmetrically opposite of one another with respect to a diametral plane of the cylinder that is determined by the axis of an exhaust port, and two injection nozzles for fuel disposed symmetrically with respect to said diametral plane, the nozzle axes of which intersect one another above the piston crown in the diametral plane in the bottom dead centre position of the piston.

### DESCRIPTION OF THE PRIOR ART

Since conventional injection nozzles can provide fuel only in a limited quantity range per injection cycle, it is known especially for powerful two-cycle combustion engines (EP 0 302 045 A2, EP 0 591 509 B1) to provide two injection nozzles, so that during a low demand for fuel in idling operation and in the lower part-load range one injection nozzle is supplied, and in the upper part-load range and under full load both injection nozzles are supplied. If the injection nozzles are arranged in such a way that they are disposed symmetrically on either side of a diametral plane extending through the axis of the exhaust port, with the nozzle axes intersecting in the cylinder axis (EP 0 591 509 B1), favorable symmetric conditions are obtained for the distribution of fuel in the combustion chamber in the higher power range when using both injection nozzles, but not in idling operation and in the lower part-load range when only one injection nozzle is used. Moreover, the two fuel jets have a considerable flow component in the direction towards the exhaust port after meeting one another in the region of the cylinder axis and the resulting fanning out of the fuel stream, leading to scavenging losses on the one hand and to increased hydrocarbon emissions on the other hand, because the air entering the combustion chamber from the crankcase via the transfer ports transversely to the direction of the fuel stream is unable to prevent the wetting of the piston crown with fuel which will flow off over the piston crown against the cylinder walls.

If on the other hand the injection nozzles are arranged non-symmetrically so that an injection nozzle lies in the diametral plane of the cylinder determined by the axis of the exhaust port, whereas the other injection nozzle is aligned with an angular offset on one side of said diametral plane in such a way that the nozzle axes of the two injection nozzles intersect on the side of the cylinder axis facing away from the exhaust port, which occurs in the bottom dead centre position of the piston beneath the piston crown (EP 0302045 A2), symmetric conditions for preparing the mixture can only be ensured in idling operation and in the lower part-load range, but not in the full-load range. An additional factor is that as a result of the nozzle alignment against the piston crown, its wetting with fuel is desirable in order to enable a respective evaporation of the fuel on the hot piston crown. It has been noticed however that the time available within the cycles for this purpose is insufficient and therefore the disadvantages prevail concerning the piston and cylinder wall surfaces wetted with fuel, especially concerning the hydrocarbon emissions.

### SUMMARY OF THE INVENTION

The invention is therefore based on the object of providing a two-cycle combustion engine of the kind mentioned above in such a way that an advantageous mixture formation is obtained both in idling operation and in the lower part-load range as well as the full-load range, in combination with a reduction of the scavenging losses and the hydrocarbon emissions.

This object is achieved by the invention in such a way that the nozzle axes intersect one another on the side of the cylinder axis facing away from the exhaust port and extend at least approximately in the outflow direction of the transfer ports respectively provided on the opposite side of the diametral plane, and the piston comprises a casing opening for injecting fuel into the crankcase on at least one circumferential side facing the injection nozzles.

As a result of the alignment of the nozzle axes relative to the outflow direction of the respectively opposite transfer port, it is possible to utilize the respectively largest relative speed for fuel preparation as a result of the oppositely directed speed components between the fuel stream injected in the direction of the nozzle axis and the air flowing in from the respectively opposite transfer port, which leads to an advantageous mixture distribution in the combustion chamber in cooperation with the arrangement symmetry when using both injection nozzles and thus in the range of higher partial loads and in full-load operation. The point of intersection of the nozzle axes on the side of the cylinder axis facing away from the exhaust port displaces the fanning of the injected fuel jets which is relevant for mixture preparation with the help of the air injected in the opposite direction relative to the fuel via the transfer ports, so that scavenging losses can be prevented to a substantial extent. It needs to be considered in this connection that the fuel jets and the oppositely directed air flows will meet one another above the piston crown, leading to a flow of the forming mixture directed away from the piston crown towards the cylinder head and preventing a wetting of the piston crown with fuel which would lead to hydrocarbon emissions.

If only one injection nozzle is used for idling operation and the lower part-load range, the fuel is injected through this injection nozzle not into the combustion chamber above the piston crown but in the known manner (AT 503 127 B1) through a casing opening of the piston into the crankcase on the circumferential side facing the injection nozzle. As a result of the flow motion in the crankcase and on the bottom side of the piston there will be a substantially even distribution of the injected fuel and, as a result, there will be an even introduction of the fuel/air mixture through the transfer ports into the combustion chamber of the cylinder. A symmetric distribution of fuel is thus ensured in the combustion chamber both in idling operation and in the lower part-load range.

In order to support an advantageous preparation of mixture when using both injection nozzles, a transfer port which is arranged as a raising port can be provided on the side of the cylinder diametrically opposite of the exhaust port, having an outflow direction directed against the cylinder head and disposed in the diametral plane and extending above the point of intersection of the nozzle axes. As a result of the flow of this raising port which meets the jets of the injected fuel before the principal fuel jets meet one another, a unified gas flow is obtained together with the streams from the transfer ports arranged symmetrically relative to the diametral plane, which gas stream is directed against the cylinder head and in which the fuel is finely distributed.

In order to achieve advantageous pressure conditions in the cylinder for the injection of the fuel, the nozzle axes of the injection nozzles can intersect the inside surfaces of the cylinder with respect to height between the timing edges of the transfer ports and the exhaust port. The injection nozzle is therefore only loaded with the low pressures at the end of the expansion phase. Moreover, the temperature is kept at a low level by the incoming fresh air, so that coking in the nozzle area can be effectively prevented. The height position of the injection nozzles relating to the timing edges of the transfer ports and the exhaust port also allows angles of inclination for the nozzle axes which are advantageous for the mixture preparation in the combustion chamber and, depending on this, the outflow sections of the transfer ports.

If at least one of the transfer ports originates from an intake opening provided in the cylinder which is opposite to a casing opening of the piston in the stroke position of the piston for the opened transfer port, an increased gas flow is obtained within the piston with the effect that no higher fuel concentration can build up in the piston area, so that all disadvantages caused by fuel enrichment in the piston area are avoided.

### BRIEF DESCRIPTION OF THE DRAWINGS

The subject matter of the invention is shown in the drawings by way of example, wherein:

FIG. 1 shows a two-cycle combustion engine in accordance with the invention in a cross-sectional view in the region of the outflow openings of the transfer ports;

FIG. 2 shows a sectional view along the line II-II in FIG. 1;

FIG. 3 shows a sectional view along the line III-III in FIG. 1;

FIG. 4 shows a sectional view along the line IV-IV in FIG. 3, and

FIGS. 5 and 6 show a sectional view along the line V-V in FIG. 1 with the piston in the upper and lower dead centre position.

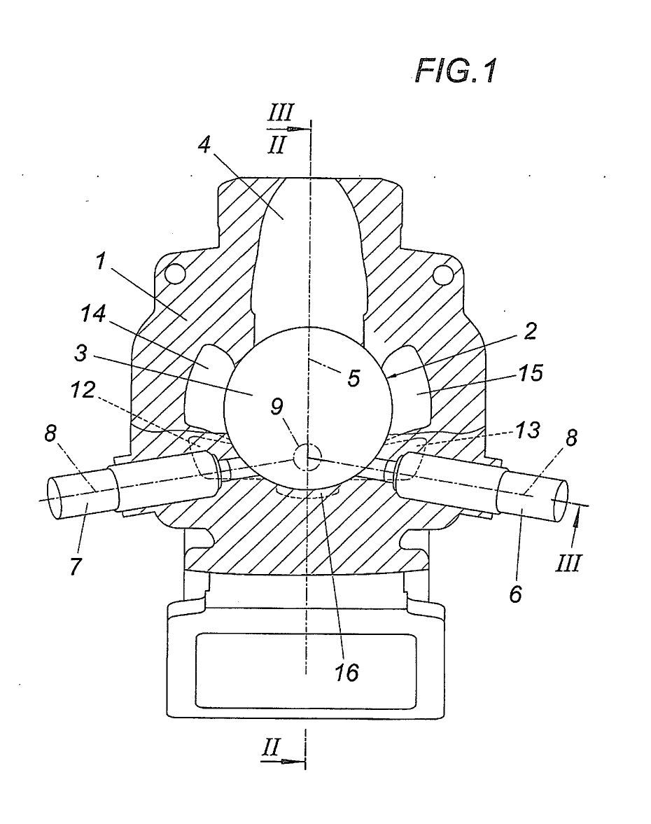

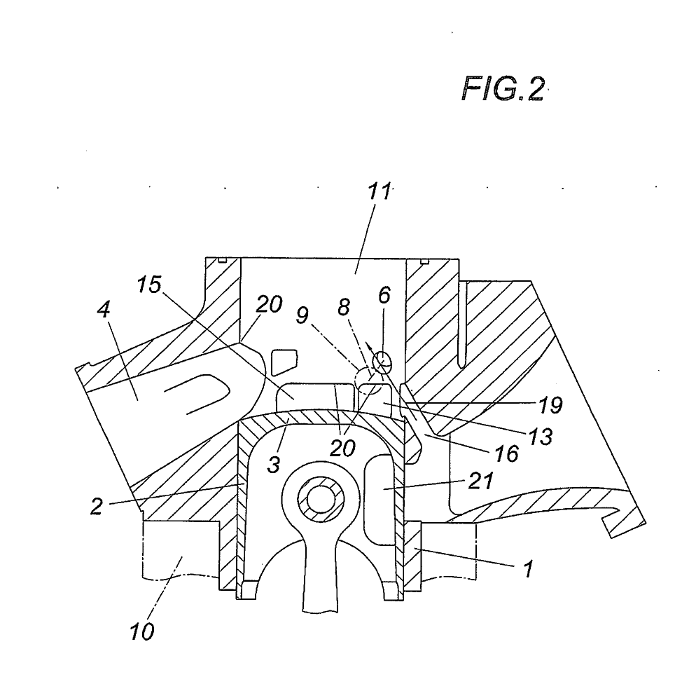

### DESCRIPTION OF THE PREFERRED EMBODIMENT

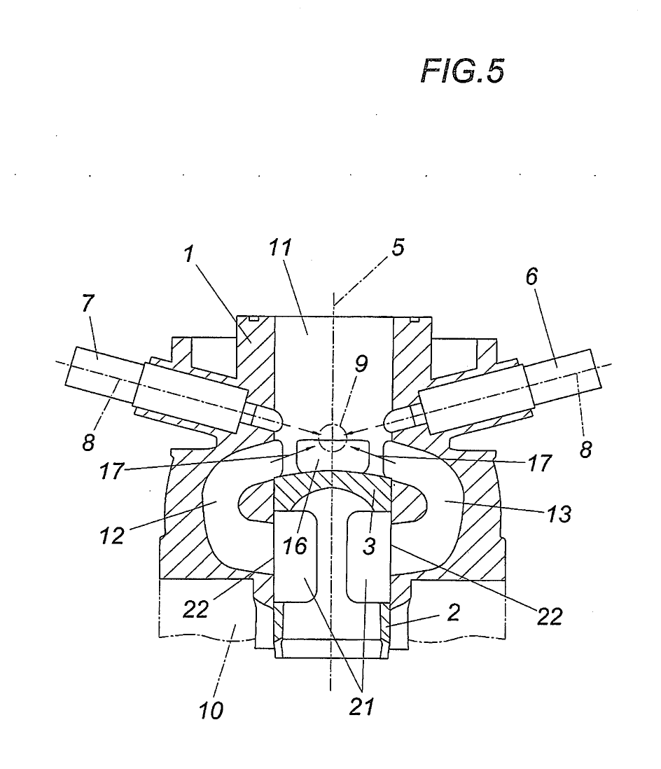

The drawing merely shows a cylinder 1 without cylinder head of a motor block of a two-cycle combustion engine. The piston shown in the bottom dead centre position is designated with reference numeral 2 and comprises a piston crown 3. On the side of the cylinder which is opposite of the exhaust port 4, two injection nozzles 6, 7 are provided symmetrically relative to a diametral plane 5 determined by the axis of the exhaust port 4, the nozzle axes 8 of which intersect in the diametral plane 5, namely in an intersecting point 9, which lies in the bottom dead centre position of piston 2 above the piston crown 3, as is shown especially in FIG. 5.

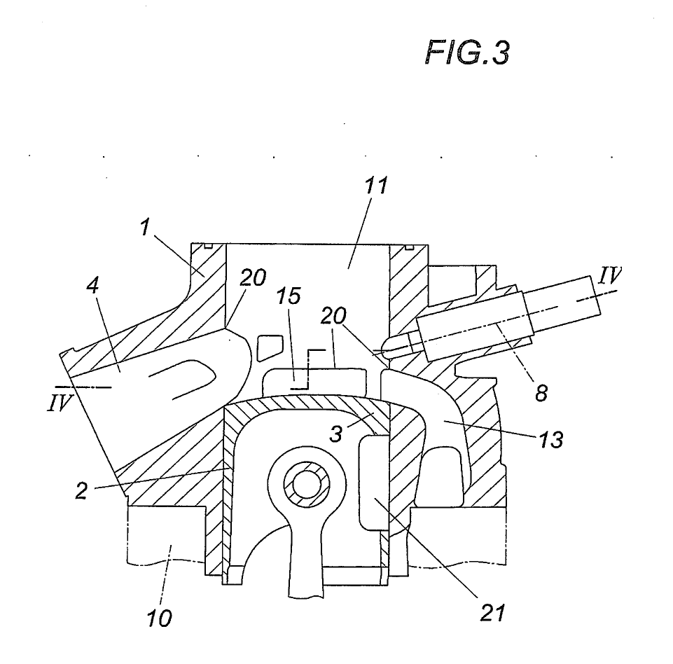

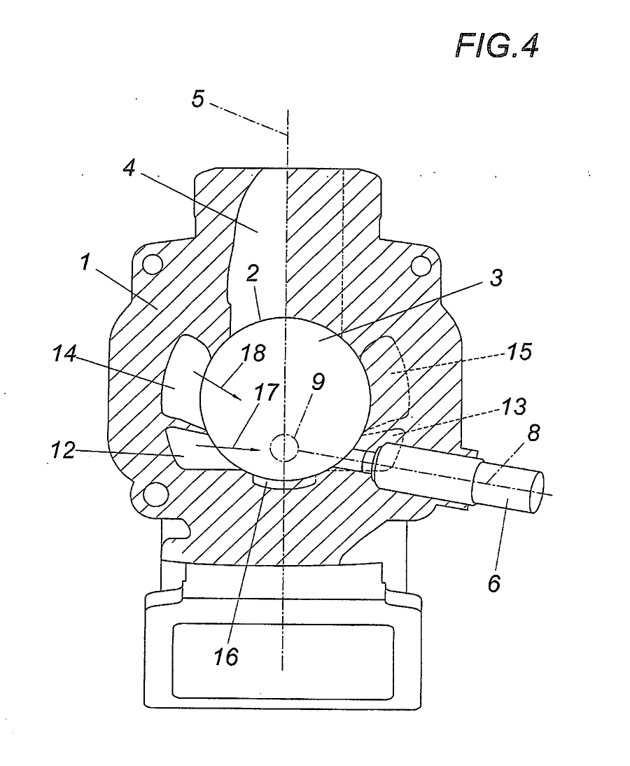

Transfer ports 12, 13 and 14, 15 are provided between the crankcase 10 and the combustion chamber 11 of the cylinder 1, which ports are opposite of one another in pairs and are arranged symmetrically in relation to the diametral plane 5. In addition, the cylinder 1 comprises a transfer port as a raising port 16 which is diametrically opposite of the exhaust port 4 and which opens into the combustion chamber 11 between the injection nozzles 6, 7, as is shown especially in FIGS. 3 and 4. The arrangement is made in such a way that the nozzle axes 8 are oppositely directed to one of the two transfer ports 12, 13 or 14, 15 opening on the cylinder side opposite with respect to the diametral plane 5, i.e. the outflow direction 17 of the transfer ports 12, 13 or the outflow direction 18 of the transfer ports 14, 15 extend in the direction of the nozzle axis 8 of the respective opposite injection nozzles 6, 7. In the present embodiment the transfer ports 12, 13 are directed oppositely in their opening area to the injection nozzles 6, 7, as is shown in FIGS. 4 and 5. This measure ensures an advantageous fanning of the injected fuel jet and a fine distribution of the fuel within the gas stream because the highest relative speed between fuel jet and air flow can be used for the distribution of the fuel as a result of the air flow directed against the fuel jet from the respectively oppositely disposed transfer ports 12, 13. The alignment of the nozzle axes 8 in the manner that their point of intersection 9 comes to lie in the bottom dead centre position of the piston 2 above the piston crown 3 prevents wetting of the piston crown with fuel which is entrained against the cylinder head away from the piston crown 3 by the fresh air injected into the combustion chamber 11 via the transfer ports 12, 13 and 14, 15, leading to an advantageous distribution of fuel in the combustion chamber 11, especially when the outflow direction 19 of the raising port 16 extends above the point of intersection 9 of the nozzle axes 8 (FIG. 3) because in this case the fresh air from the raising port 16 will meet the fuel jets before the main streams of these fuel jets will unite, so that the discharge of the fuel from the piston crown 3 is already initiated and supported by the air flow from the raising port 16. The likelihood that fuel is partly discharged together with the exhaust gas through the exhaust port 4 is counteracted in such a way that the point of the section 9 of the nozzle axes 8 lies on the side of the cylinder axis facing away from the exhaust port 4 and consequently the originating gas flows entrain the fuel injected via the injection nozzles 6, 7 away from the exhaust port 4 towards the cylinder head.

In order to ensure that advantageous pressure conditions can be utilized for fuel injection, the nozzle axes 8 intersect the inside surfaces of the cylinder with respect to height between the timing edges 20 of the transfer ports 12, 13, 14, and of the exhaust port 4, as is shown in FIG. 3. This arrangement ensures that the injection nozzles 6, 7 are loaded only with low pressures at the end of the expansion phase and are protected from combustion residues by deposits because the coking temperature required for this purpose is not achieved as a result of the fresh air which flows in via the raising port 16 and which displaces the hot exhaust gases from the nozzle area.

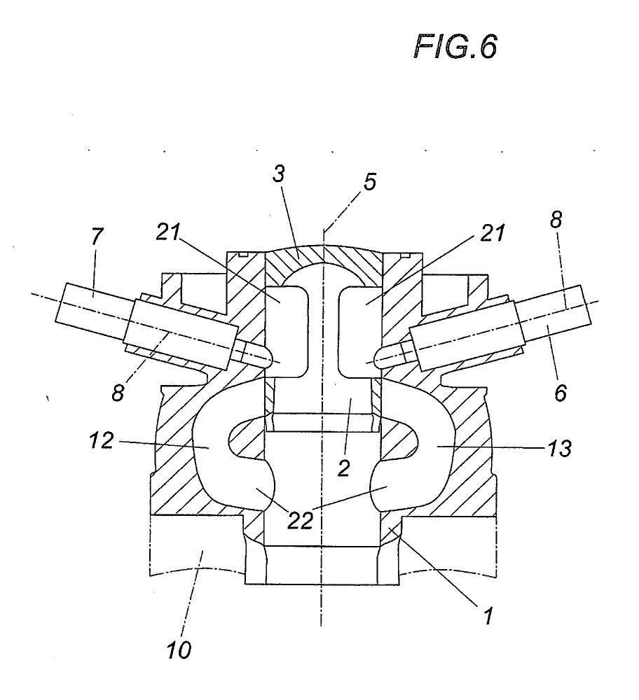

In order to enable the use of only one injection nozzle in idling operation and in the lower part-load range without having to fear a non-symmetric distribution of fuel in the combustion chamber 11, the fuel can be injected through a casing opening 21 into the piston 2 when using only one injection nozzle, as is indicated in FIG. 6. Such an injection of fuel requires a respective triggering of the injection nozzle 6 during the compression phase. Although the fuel injection into the piston 2 will occur only by one of the injection nozzles 6, 7 in most cases, it is also possible to trigger both of the injection nozzles 6, 7 accordingly when the piston 2 comprises two casing openings 21 which are associated to one injection nozzle 6, 7 each. By introducing the fuel via the piston 2 into the crankcase 10, the fuel is mixed together with the fresh air drawn into the crankcase 10 and is conveyed via the transfer ports 12 to 16 into the combustion chamber 11, with a respective equal distribution of the fuel occurring as a result of the gas streams. There is a likelihood however that a fuel-enriched charge zone is obtained on the bottom side of piston in the region of the piston crown 3. For the purpose of preventing such fuel-enriched areas, the transfer ports 12, 13 can originate from an intake opening 22 provided in the cylinder 1, which are opposite of the casing openings 21 of the piston 2 in the stroke range of piston 2 for the opened transfer ports (FIG. 5), so that as a result of the flow through these transfer ports 12, 13 the gas areas beneath the piston crown 3 are captured and scavenged into the combustion chamber 11. Since the gas mixture through these transfer ports 12, 13 then have a higher percentage of fuel than the gas mixtures in the transfer ports 14, 15 adjacent to the exhaust port 4, a reduction in the scavenging losses and the resulting hydrocarbon emissions can be achieved. A similar effect occurs when scavenging of the bottom side of the piston occurs via the raising port 16, which is then supplied with the fuel/air mixture from the crankcase 10 by a respective casing opening in piston 2.

1. A two-cycle combustion engine, comprising at least one cylinder (1) accommodating a piston (2) and provided with a cylinder head, a crankcase (10) which is in fluid connection with the cylinder (1) by way of transfer ports (12 to 16) which are disposed symmetrically opposite of one another with respect to a diametral plane (5) of the cylinder (1) that is determined by the axis of an exhaust port (4), and two injection nozzles (6, 7) for fuel disposed symmetrically with respect to said diametral plane (5), the nozzle axes (8) of which intersect one another above the piston crown (3) in the diametral plane (5) in the bottom dead center position of the piston (2), wherein the nozzle axes (8) intersect one another on the side of the cylinder axis facing away from the exhaust port (4) and extend at least approximately in the outflow direction (17) of the transfer ports (12, 13) respectively provided on the opposite side of the diametral plane (5), and the piston (2) comprises a casing opening (21) for injecting fuel into the crankcase (10) on at least one circumferential side facing the injection nozzles (6, 7).

2. A two-cycle combustion engine according to claim 1, wherein a transfer port which is arranged as a raising port (16) is provided on the side of the cylinder (1) diametrically opposite of the exhaust port (4), having an outflow direction (19) which is directed against the cylinder head, disposed in the diametral plane (5) and extends above the point of intersection (9) of the nozzle axes (8).

3. A two-cycle combustion engine according to claim 1, wherein the nozzle axes (8) of the injection nozzles (6, 7) intersect the inside surfaces of the cylinder with respect to height between the timing edges (20) of the transfer ports (12, 13, 14, 15) and the exhaust port (4).

4. A two-cycle combustion engine according to claim 1, wherein at least one of the transfer ports (12 to 16) originates from an intake opening (22) provided in the cylinder (1) which is opposite to a casing opening (21) of the piston (2) in the stroke position of the piston (2) for the opened transfer port (12 to 16).
